(19) United States
(12) Patent Application Publication
(10) Pub. No.: US 2019/0284976 A1
(43) Pub. Date: Sep. 19, 2019

(54) OIL PAN GUARD BRACKET

(71) Applicant: Toyota Jidosha Kabushiki Kaisha, Toyota-shi (JP)

(72) Inventor: Ryuusuke NAKAYAMA, Seto-shi (JP)

(73) Assignee: TOYOTA JIDOSHA KABUSHIKI KAISHA, Toyota-shi (JP)

(21) Appl. No.: 16/292,590

(22) Filed: Mar. 5, 2019

(30) Foreign Application Priority Data
Mar. 14, 2018 (JP) 2018-046410

(51) Int. Cl. F01M 11/10

(52) U.S. Cl. CPC F01M 11/10; F16N 31/006

(57) ABSTRACT

An oil pan guard bracket for securing an oil pan guard to a vehicle body frame includes a flat securing base to which the oil pan guard is secured and two inclined wall portions, each of which extends obliquely upwards and outwards from opposite sides of the flat securing base. Each inclined wall portion includes an opposing edge which opposes a side surface of the vehicle body frame. The opposing portion of each inclined wall portion is welded to the side surface of the vehicle body frame.

### CROSS REFERENCE TO RELATED APPLICATION

This application claims priority to Japanese Patent Application No. 2018-046410 filed on Mar. 14, 2018, which is incorporated herein by reference in its entirety including the specification, claims, drawings, and abstract.

### TECHNICAL FIELD

The present disclosure relates to an oil pan guard bracket for securing an oil pan guard to a vehicle body frame.

### BACKGROUND

Conventionally, oil pan guards (shields) are provided under transmission oil pans with space therebetween to avoid exposure of the oil pans at the bottoms of vehicle bodies. In such a vehicle, for example, when road debris such as a large stone hits the bottom of the vehicle body during driving or the vehicle body approaches it, the oil pan guard can protect the oil pan from the impact and avoid damage of the oil pan. Oil pan guards are secured to vehicle body frames via oil pan guard brackets (refer to, for example, JP H50-10173 U).

### CITATION LIST

### Patent Literature

Patent Document 1: JP H05-10173 U

### SUMMARY

When a large stone or other debris hits the bottom of a vehicle body to impose a load to an oil pan guard from below, the load may be transmitted to a vehicle body frame via a bracket, causing deformation of the vehicle body frame. It has been desired to reduce deformation of a vehicle body frame due to a load from an oil pan guard.

An object of the present disclosure is to provide, in a vehicle with an oil pan guard secured to a vehicle body frame via an oil pan guard bracket, the oil pan guard bracket being able to reduce deformation of the vehicle body frame due to a load from the oil pan guard.

An oil pan guard bracket according to the present disclosure secures an oil pan guard to a vehicle body frame. The oil pan guard bracket includes a flat securing base to which the oil pan guard is secured, and two inclined wall portions, each of which extends obliquely upwards and outwards from opposite sides of the flat securing base. Each of the inclined wall portions includes an opposing edge which opposes a side surface of the vehicle body frame. The opposing edge of each of the inclined wall portions is welded to the side surface of the vehicle body frame.

In an oil pan guard bracket according to an embodiment of the present disclosure, a distal portion of the opposing edge of each of the inclined wall portions may be welded to the side surface of the vehicle body frame, while a remaining portion of the opposing edge may be a free area which is not welded to the side surface of the vehicle body frame.

In an oil pan guard bracket according to an embodiment of the present disclosure, a securing portion to which the oil pan guard is secured may be disposed on the flat securing base and positioned away from the side surface of the vehicle body at a predetermined distance.

In an oil pan guard bracket according to an embodiment of the present disclosure, an edge of the flat securing base opposing the vehicle body frame may be welded to the vehicle body frame.

According to an oil pan guard bracket of an exemplary embodiment of the present disclosure, when a load is transmitted from an oil pan guard, the load is absorbed by deflection of the inclined wall portions of the oil pan guard bracket. Because the load transmitted to the vehicle body frame is accordingly reduced, deformation of the vehicle body frame can be reduced.

### BRIEF DESCRIPTION OF DRAWINGS

Embodiment(s) of the present disclosure will be described by reference to the following figures, wherein:

FIG. 1 is a plan view of a vehicle body frame;

FIG. 2 is a perspective view of an oil pan guard;

FIG. 3 is a cross sectional view taken along the line A-A in FIG. 1;

FIG. 4 is a perspective view of an oil pan guard bracket;

FIG. 5 is perspective view showing the oil pan guard bracket welded to a side surface of the vehicle body frame;

FIG. 6 is a cross sectional view taken along the line B-B in FIG. 1; and

FIG. 7 is a drawing used to describe a force imposed to the oil pan guard bracket.

### DESCRIPTION OF EMBODIMENTS

Exemplary embodiments of an oil pan guard according to the present disclosure are described below with reference to the attached drawings.

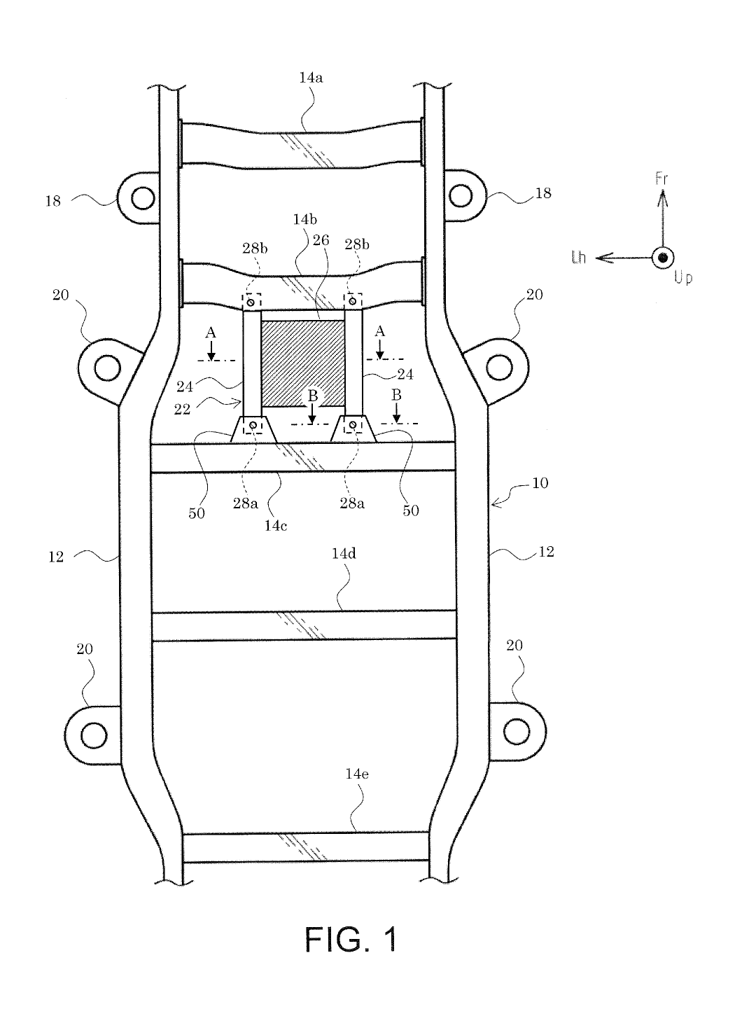

FIG. 1 is a plan view of a vehicle body frame 10 according to an exemplary embodiment of the present disclosure. The vehicle body frame 10 is disposed under a vehicle body. In FIG. 1 and any of the other drawings described below, arrows Fr, Up, and Lh respectively show the front, up, and left directions of the vehicle body. As shown in FIG. 1, the vehicle body frame 10 includes a pair of side rails 12 extending along a longitudinal axis of the vehicle on both sides of the vehicle, and two or more cross members 14a, 14b, 14c, 14d, and 14e. The right and left side rails 12 are connected via the cross members 14a, 14b, 14c, 14d, and 14e extending along a lateral axis of the vehicle to form the vehicle body frame 10 of a substantially ladder shape. Each of the side rails 12 and the cross members 14a, 14b, 14c, 14d, and 14e is made of a metal material such as steel and has a substantially rectangular closed cross section.

Two suspension mount brackets 18 made of metal are provided, each on the right and left side rails 12 between the cross members 14a and 14b such that each suspension mount bracket 18 protrudes outward in a vehicle lateral direction from an outer wall of each side rail 12. A suspension mount (not shown) is attached to each of the two suspension mount brackets 18. A suspension unit (not shown) is attached to each side rail 12 via the suspension mount and the suspension mount bracket 18.

Four body mount brackets 20 made of metal are attached to the outer walls of the side rails 12. Each of the body mount brackets 20 protrudes outward in a vehicle lateral direction. Two of the four body mount brackets 20 are disposed between the cross members 14b and 14c, and the other two between the cross members 14d and 14e. A rubber mount (not shown) is attached to each body mount bracket 20. A vehicle body (not shown) is mounted on the side rails 12 via the four rubber mounts and the four body mount brackets 20.

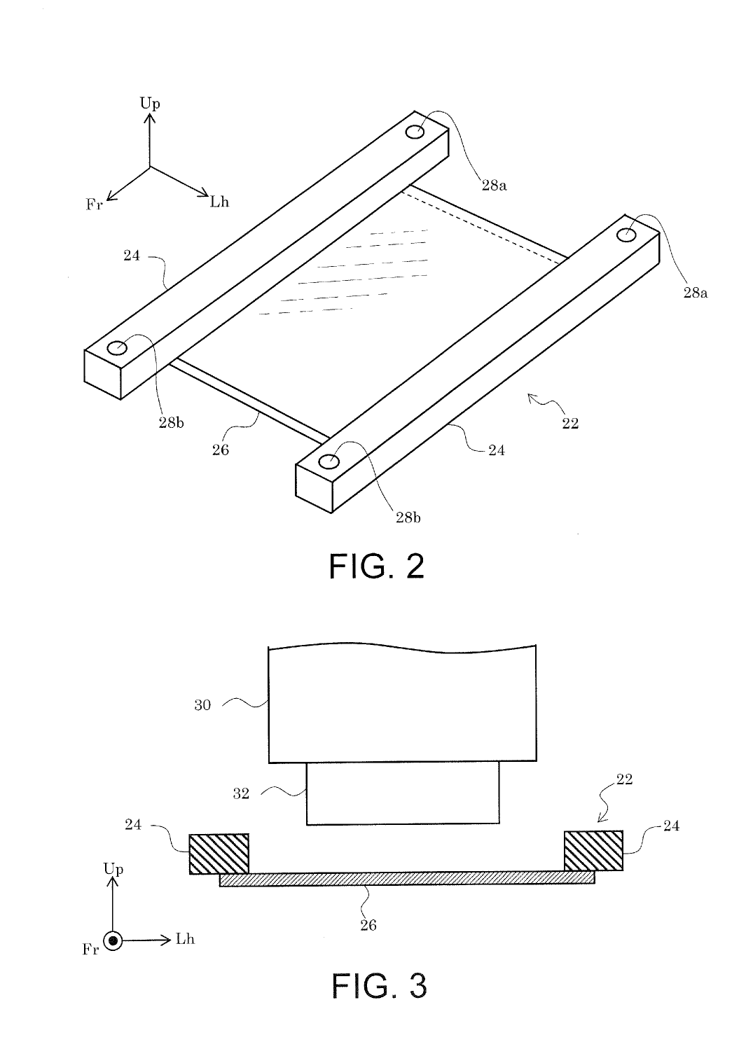

An oil pan guard 22 is disposed across the cross members 14b and 14c. FIG. 2 is a perspective view of the oil pan guard 22. As shown in FIG. 2, the oil pan guard 22 includes two bar-shaped members 24 extending along the longitudinal axis of the vehicle on both sides of the vehicle, and a plate-shaped member 26 secured to the underside of the two bar-shaped members 24 to be disposed therebetween. For example, each bar-shaped member 24 is made of metal and has a rectangular cross section. The plate-shaped member 26 has a certain thickness and is, for example, a steel plate. Each bar-shaped member 24 includes, around a front end, a securing hole 28b for securing the bar-shaped member 24 to the cross member 14b. Each bar-shaped member 24 also includes, around a rear end, another securing hole 28a for securing the bar-shaped member 24 to the cross member 14c via an oil pan guard bracket described below. The securing holes 28a, 28b are through-holes extending along a vertical axis of the vehicle.

As shown in FIG. 1, the front ends of the two bar-shaped members 24 of the oil pan guard 22 are disposed under the cross member 14b. The cross member 14b includes two through-holes (not shown) extending along the vertical axis of the vehicle corresponding to the two securing holes 28b of the oil pan guard 22. The two securing holes 28b of the oil pan guard 22 are aligned with the two through-holes of the cross member 14b. Two bolts are respectively inserted into the securing holes 28b from below the two bar-shaped members 24 of the oil pan guard 22. Each bolt is further inserted through each through-hole of the cross member 14b to protrude from the upper surface of the cross member 14b and be screwed into a nut. In this way, the front of the oil pan guard 22 is secured to the cross member 14b.

As shown in FIG. 1, two oil pan guard brackets 50 are welded to the cross member 14c. The rear of the oil pan guard 22 is secured to the cross member 14c via two oil pan guard brackets 50. This connection is described in more detail further below.

FIG. 3 is a cross sectional view taken along the line A-A in FIG. 1. As shown in FIG. 3, a transmission 30 and an oil pan 32 under the transmission 30 are disposed over the plate-shaped member 26 of the oil pan guard 22 with space therebetween. The bottom of the oil pan 32 is positioned entirely behind the plate-shaped member 26 of the oil pan guard 22 when viewed from below. In this way, when a large stone or other debris hits the bottom of the vehicle body during driving or the vehicle approaches it, the plate-shaped member 26 of the oil pan guard 22 avoids impact to the oil pan 32 and protects the oil pan 32 from damage.

The oil pan guard bracket 50 according to an exemplary embodiment of the present disclosure is described below. The oil pan guard brackets 50 are welded to the cross member 14c. In the description below, the oil pan guard bracket 50 may also be referred to simply as the bracket 50.

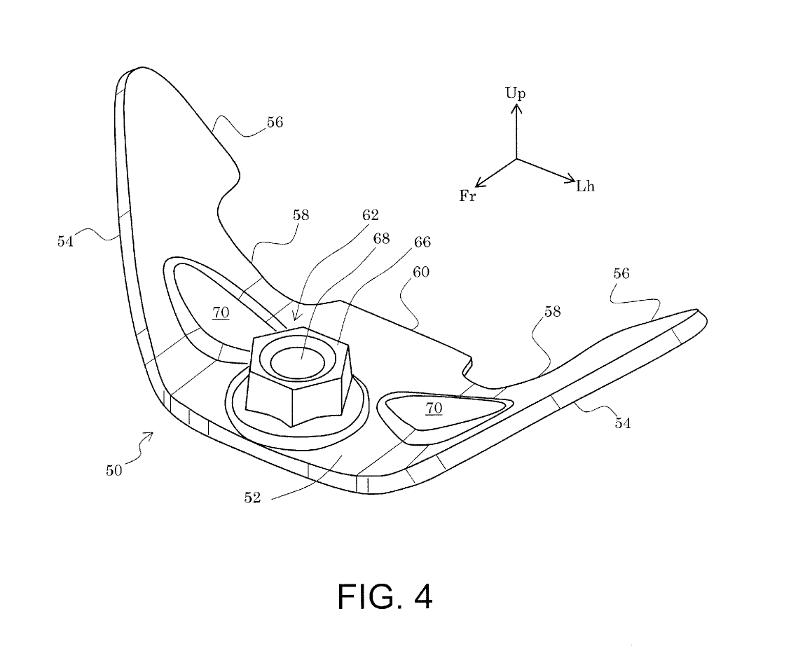

FIG. 4 is a perspective view of the oil pan guard bracket 50. As shown in FIG. 4, each bracket 50 includes a flat securing base 52 to which the oil pan guard 22 is secured, and two inclined wall portions 54, each of which extends obliquely upwards and outwards from each of opposite sides of the flat securing base 52. The bracket 50 is made of, for example, metal. The securing base 52 and the inclined wall portions 54 are formed by bending a plate of a certain thickness such that the inclined wall portions 54 are bent to be obliquely upwards with respect to the securing base 52. A bead 70 is formed between the securing base 52 and each of the two inclined wall portions 54. Each bead 70 rises from the upper surface (convex type). The beads 70 are formed after the bending process to prevent the inclined wall portions 54 from returning to flat positions. The beads 70 may have a groove shape formed in the upper surface (concave type).

A securing portion 62 for securing the oil pan guard 22 is formed on the flat securing base 52 of the oil pan guard bracket 50. The securing portion 62 on the securing base 52 is positioned nearer to the front edge of the securing base 52 than to the rear edge such that the securing portion 62 is positioned away from a side surface of the cross member at a predetermined distance when the bracket 50 is welded to the cross member. The securing portion 62 includes a flange nut 66 secured on the upper surface of the securing base 52. The securing base 52 includes a vertical through-hole (not shown) which is aligned with a hole 68 of the flange nut 66. The flange nut 66 may be separately provided from the brackets 50, not as a nut secured on the upper surface of the securing base 52. In that case, the flange nut 66 may be not a flange nut but a nut and a washer.

As shown in FIG. 4, each of the two inclined wall portions 54 of the bracket 50 includes an opposing edge 56 which opposes a side surface of the cross member. The edge 56 of the inclined wall portion 54 on a securing base 52 side is cut out to form a notch 58. The securing base 52 of the bracket 50 includes an edge 60 which opposes the side surface of the cross member.

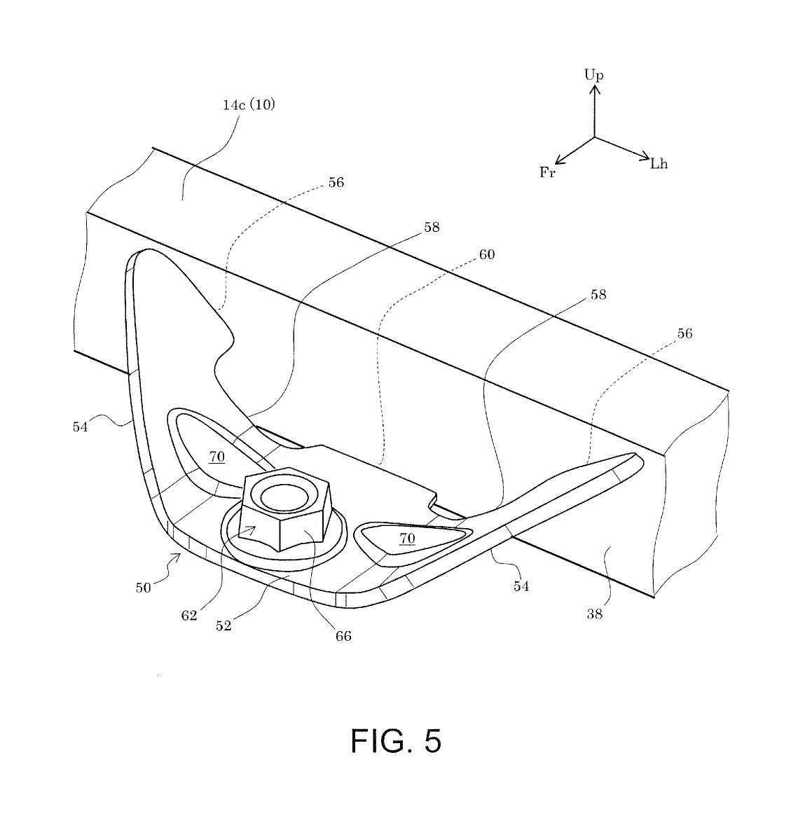

FIG. 5 is a perspective view showing the bracket 50 which is welded to the side surface of the cross member 14c (the vehicle body frame 10). As shown in FIG. 5, the edge 56 of each inclined wall portion 54 on a distal end side is welded to the side surface 38 of the cross member 14c. The notch 58 of the edge 56 of the inclined wall portion 54 on the securing base 52 side is a free area which is not welded to the side surface 38 of the cross member 14c. The edge 60 of the securing base 52 is welded to the side surface 38 of the cross member 14c. The bracket 50 can be more securely attached to the cross member 14c by welding, in addition to the inclined wall portions 54, the securing base 52 to the side surface 38 of the cross member 14c.

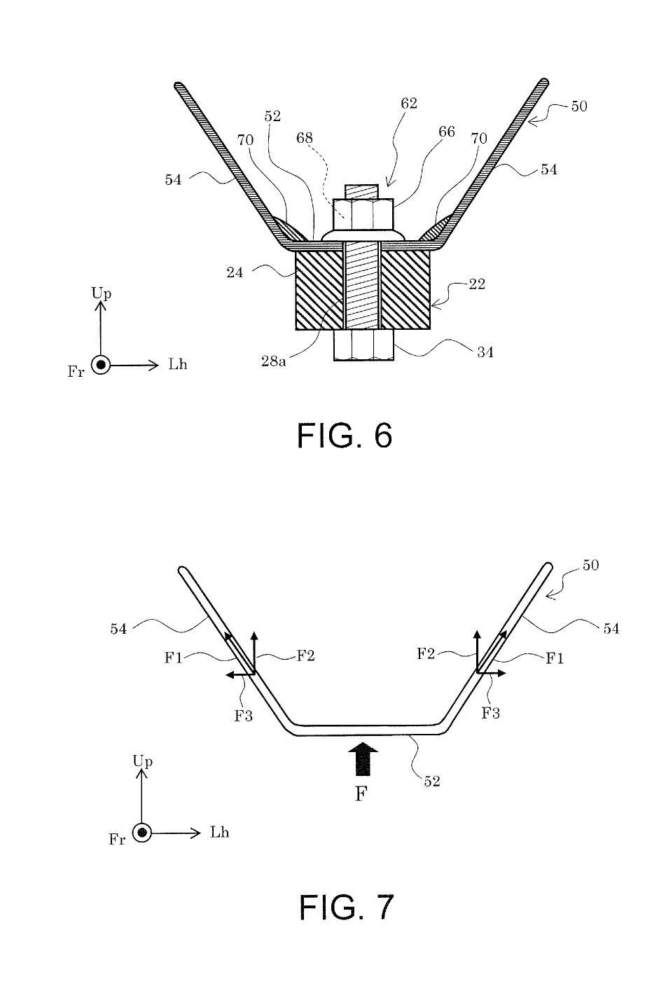

Described below is how the oil pan guard 22 is secured to the cross member 14c via the brackets 50. FIG. 6 is a cross sectional view taken along the line B-B in FIG. 1. As shown in FIG. 6, each of the bar-shaped members 24 of the oil pan guard 22 is positioned to be in contact with a lower surface of the flat securing base 52 of the bracket 50. The securing hole 28a formed in each bar-shaped member 24 of the oil pan guard 22 is aligned with the through-hole formed in the securing base 52 of the bracket 50. A bolt 34 is inserted into the securing hole 28a from below the bar-shaped members 24 of the oil pan guard 22. The bolt 34 is further inserted through the through-hole of the securing base 52 of the bracket 50, and is screwed into the hole 68 of the flange nut 66. In this way, the rear end of each bar-shaped member 24 of the oil pan guard 22 is secured to the bracket 50. As shown in FIG. 1, according to the present embodiment, the two brackets 50 are spaced apart from each other and welded to the side surface of the cross member 14c. The rear ends of the two bar-shaped members 24 of the oil pan guard 22 are respectively secured to these two brackets 50.

Advantages of the oil pan guard bracket 50 according to the present embodiment are described below.

When a large stone or other debris hits under the plate-shaped member 26 of the oil pan guard 22 and a load is transmitted to the bracket 50 from the oil pan guard 22, the oil pan guard bracket 50 according to the present disclosure can absorb the load by deflection of the inclined wall portions 54 of the bracket 50. Because the load imposed to the cross member 14c (the vehicle body frame 10) from the brackets 50 can be reduced in this way, deformation of the cross member 14c (the vehicle body frame 10) can be inhibited.

As shown in FIG. 7, a load F from the oil pan guard 22 is imposed to the lower surface of the securing base 52 of the bracket 50. Then, a force F1 is transmitted to each of the two inclined wall portions 54. Because the inclined wall portions 54 are inclined, the force F1 can be considered to be separated to an upward force F2 and a lateral force F3. The inclined wall portions 54 can absorb the load F from the oil pan guard 22 because the inclined wall portions 54 elastically deform or deflect due to the forces F2 and F3 in two different directions.

In the brackets 50 according to the present embodiment, the edge 56 of the inclined wall portion 54 on the distal end side is welded to the side surface 38 of the cross member 14c. A remaining portion (notch 58) of the edge 56 is a free area which is not welded to the side surface 38 of the cross member 14c. In this way, when a load is transmitted from the oil pan guard 22, the load can be effectively absorbed because the inclined wall portion 54 can be sufficiently deflected in this free area of the inclined wall portion 54.

Even with no free area (notch 58); that is, when the entire edge 56 of the inclined wall portion 54 is welded to the side surface 38 of the cross member 14c, the load F transmitted from the oil pan guard 22 can be absorbed by the bracket 50. As shown in FIG. 5, when the securing portion 62 of the oil pan guard 22 is positioned, on the securing base 52, to be away from the side surface 38 of the cross member 14c (the vehicle body frame 10), the load on the securing base 52 and the inclined wall portion 54 becomes heavier in areas away from the side surface 38 of the cross member 14c. In this way, even when the entire edges 56 of the inclined wall portions 54 are welded to the side surface 38 of the cross member 14c with no free areas (notch 58) such that the inclined wall portions 54 near the side surface 38 of the cross member 14c cannot be deflected, the inclined wall portions 54 can still be deflected in areas away from the side surface 38 of the cross member 14c (where the load is heavier), allowing absorption of the imposed load.

Variations of the oil pan guard brackets 50 are described below.

In the oil pan guard bracket 50 according to the above described embodiment, the edge 60 of the securing base 52 is welded to the side surface 38 of the cross member 14c. However, part of the securing base 52 of the bracket 50 may be positioned under the cross member 14c and the upper surface of the part of the securing base 52 may be welded to the lower surface of the cross member 14c. This structure can also achieve secure attachment of the oil pan guard bracket 50 to the cross member 14c.

Further, when the bracket 50 is securely attached to the cross member 14c by welding the inclined wall portions 54 of the bracket 50, the securing base 52 of the bracket 50 may be left unwelded to the cross member 14c. Without welding the securing base 52 to the cross member 14c, the load received from the oil pan guard 22 can be more easily transmitted to the inclined wall portions 54, allowing more efficient absorption of the load by the inclined wall portions 54.

In the above embodiments, the oil pan guard brackets 50 are not used for the cross member 14b. However, similarly as for the cross member 14c, the brackets 50 may be welded to the cross member 14b to secure the oil pan guard 22 to the cross member 14b via the brackets 50.

Although the oil pan guard 22 according to the above described embodiments is positioned between the cross member 14b and the cross member 14c, the oil pan guard 22 may be positioned between other cross members. The oil pan guard 22 may also be disposed across the two side rails 12. In that case, similarly as for the cross member 14c, the brackets 50 may be welded to the side surface of either one or both of the side rails 12.

Although exemplary embodiments and variations of the oil pan guard brackets according to the present disclosure are described above, the oil pan guard brackets according to the present disclosure are not limited to the above described embodiments and variations. Obviously, the oil pan guard brackets according to the present disclosure can be implemented in a variety of other embodiments without departing from the scope of the present disclosure.

1. An oil pan guard bracket for securing an oil pan guard to a vehicle body frame, the oil pan guard bracket comprising:
a flat securing base to which the oil pan guard is secured; and
two inclined wall portions, each extending obliquely upwards and outwards from opposite sides of the flat securing base,
wherein each of the inclined wall portions comprises an opposing edge which opposes a side surface of the vehicle body frame, and
the opposing edge of each of the inclined wall portions is welded to the side surface of the vehicle body frame.

2. The oil pan guard bracket according to claim 1, wherein
a distal portion of the opposing edge of each of the inclined wall portions is welded to the side surface of the vehicle body frame, while a remaining portion of the opposing edge is a free area which is not welded to the side surface of the vehicle body frame.

3. The oil pan guard bracket according to claim 1, wherein
a securing portion to which the oil pan guard is secured is disposed on the flat securing base and is positioned away from the side surface of the vehicle body frame at a predetermined distance.

4. The oil pan guard bracket according to claim 2, wherein
a securing portion to which the oil pan guard is secured is disposed on the flat securing base and is positioned away from the side surface of the vehicle body frame at a predetermined distance.

5. The oil pan guard bracket according to claim 1, wherein
an edge of the flat securing base opposing the vehicle body frame is welded to the vehicle body frame.

6. The oil pan guard bracket according to claim 2, wherein
an edge of the flat securing base opposing the vehicle body frame is welded to the vehicle body frame.

7. The oil pan guard bracket according to claim 3, wherein
an edge of the flat securing base opposing the vehicle body frame is welded to the vehicle body frame.

8. The oil pan guard bracket according to claim 4, wherein
an edge of the flat securing base opposing the vehicle body frame is welded to the vehicle body frame.
